(19) United States
(12) Patent Application Publication
(10) Pub. No.: US 2014/0274332 A1
(43) Pub. Date: Sep. 18, 2014

(54) VERSATILE AUTOMATED WAGERING SYSTEM

(71) Applicant: John Tyler Carlin, Boston, MA (US)

(72) Inventor: John Tyler Carlin, Boston, MA (US)

(21) Appl. No.: 14/209,791

(22) Filed: Mar. 13, 2014

Related U.S. Application Data
(60) Provisional application No. 61/780,968, filed on Mar. 13, 2013.

(51) Int. Cl. G07F 17/32

(52) U.S. Cl. CPC G07F 17/3244
USPC 463/25

(57) ABSTRACT

Systems and methods can support an automated wagering system. The system can specify a payout scenario. The system can specify a number of wager options. The system can assign outcomes of the specified payout scenario to each of the specified number of wager options. The system can receive one or more wagers, from one or more users, each wager for a selected wager option. The system can receive from the one or more users, a payment for each wager. The system can price future wager options based on prior wager options. The system can calculate a purchase option metric to determine if the house should opt to purchase unselected wager options. The system can identify a winning wager from actual payout event. The system can allocate some or all of the received payments to one or more of the one or more users in response to the user being associated with the winning wager. Also, the system can allocate the received payments not allocated to the user to the house.

### RELATED APPLICATION

This application claims priority to U.S. Provisional Patent Application No. 61/780,968, filed Mar. 13, 2013 and entitled “Wagering Game.” The complete disclosure of the above-identified priority application is hereby fully incorporated herein by reference.

### BACKGROUND

Traditional wagering on sporting games or other scored events has always been quite popular. Unfortunately, allowing bettors to wager on any possible outcome of such an event can introduce increased complexity and risk for bookmakers, casinos, and other gaming entertainment providers.

There is a need in the art for gambling service providers to manage risk while providing a wide range of wager options for sports and other games. There is a further need for such wagers to be centrally and collectively managed in an autonomous fashion to keep play exciting without losing control of expected loss exposure.

### SUMMARY

In certain example embodiments described herein, methods and systems can support automated wagering systems. The system can specify a payout scenario. The system can specify a number of wager options. The system can assign outcomes of the specified payout scenario to each of the specified number of wager options. The system can receive one or more wagers, from one or more users, each wager for a selected wager option. The system can receive from the one or more users, a payment for each wager. The system can calculate a purchase option metric to determine if the house should opt to purchase unselected wager options. The system can identify a winning wager from actual payout event. The system can allocate some or all of the received payments to one or more of the one or more users in response to the user being associated with the winning wager. Also, the system can allocate the received payments not allocated to the user to the house.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting an automated wagering system in accordance with one or more embodiments presented herein.

FIG. 2 is an example structure illustrating a wagering game matrix in accordance with one or more embodiments presented herein.

FIG. 3 is an example structure illustrating a wagering game matrix where the house elects not to purchase all remaining non-purchased squares in accordance with one or more embodiments presented herein.

FIG. 4 is an example structure illustrating a historical outcome matrix in accordance with one or more embodiments presented herein.

FIG. 5 is an example structure illustrating a wagering game matrix useful for dynamic wager pricing.

FIG. 6 is a block flow diagram depicting a method for automated wagering in accordance with one or more embodiments presented herein.

FIG. 7 is a block diagram depicting a computing machine and a module in accordance with one or more embodiments presented herein.

### DETAILED DESCRIPTION OF EXAMPLE EMBODIMENTS

### Overview

The methods and systems described herein enable a versatile automated wagering system. The wagering game can provide wagers with respect to any sport, contest, election, or event where a score, count, valuation, vote, or other metric is assigned to each of two rivals. For example, the wager game may provide wagers with respect to a football game such as a super bowl. When the wagering game is based upon a football game, the wagering game may be referred to as “football squares” or “super bowl squares.”

The technology presented herein can be automated as one or more modules of one or more computing machines for wagering in conjunction with any live sporting event. A ten-by-ten matrix may be constructed and opposing teams for a chosen event are assigned separately to either the horizontal or vertical axis. The same dollar value may then be assigned to each of the 100 squares. The total potential winnings for each of the 100 possible buyers is therefore equal to the sum of the purchase amounts for all 100 squares, less any commission paid to the operator (or the “house”) for the game. The winner is determined by having been assigned a random ordered pair of integers that correctly matches the home and away scoring digits, ordered respectively, at a pre-specified point (for example, the end) within the game for the chosen live sporting event.

The wagering game can be designed to provide users a set winning payout given the uncertainty that all 100 squares will be sold prior to the start of a chosen game. A house option may be designed to provide a slight house edge in order to compensate for guaranteeing a set payout, potentially in excess of the total wagers collected from squares purchased.

The functionality of the various example embodiments will be explained in more detail in the following description, read in conjunction with the figures illustrating the program flow. Turning now to the drawings, in which like numerals indicate like (but not necessarily identical) elements throughout the figures, example embodiments are described in detail.

### Example System Architectures

FIG. 1 is a block diagram depicting an automated wagering system 100 in accordance with one or more embodiments presented herein. The automated sports wagering system 100 can allow users 110 to place wagers using user terminals 120. The user terminal 120 can communication with a wagering server 150 via a communications network 140. The wagering server 150 can collect and process wagers from various users 110 interacting with one or more user terminals 120. The methods and processes described herein in support of wagering may be implemented within a user module 130 associated with the user terminal 120, a server module 150 associated with the wagering server 150, or some combination of both the user module 130 and the server module 150.

The user terminal 120 may be a personal or mobile computer, smartphone, or other computing machine associated with the user 110. The user 110 can use a browser, an application, or other software associated with the user terminal 120 and the user module 130 to interface with the wagering server 150. According to one or more embodiments, the user terminal 120 may be directly connected to, or part of, the wagering server 150.

The user terminal 120, the wagering server 150, and any other computing machines associated with the technology presented herein may be any type of computing machine such as, but not limited to, those discussed in more detail with respect to FIG. 7. Furthermore, any modules (such as the user module 130 or the server module 160) associated with any of these computing machines or any other modules (scripts, web content, software, firmware, or hardware) associated with the technology presented herein may by any of the modules discussed in more detail with respect to FIG. 7. The computing machines discussed herein may communicate with one another as well as other computer machines or communication systems over one or more networks such as network 140. The network 140 may include any type of data or communications network including any of the network technology discussed with respect to FIG. 7.

FIG. 2 is an example structure illustrating a wagering game matrix 200 in accordance with one or more embodiments presented herein. In association with the wagering game, a ten-by-ten grid may be formed providing one hundred squares representing participant wager selections as a wagering game matrix 200. In an example where a football game is being wagered on, one team in the football game may be assigned to the columns 210 of the wagering game matrix 200 and the other team to the rows 220 of the wagering game matrix 200. Participants in the wagering game can select to wager on one or more wager options represented as he squares within the wagering game matrix 200. The ten numbers zero through nine may be randomly assigned to the rows 220 of the grid. The numbers may be assigned exclusively with each one of the ten numbers assigned as score values 225 to one of the ten rows 220. The ten numbers zero through nine may also be randomly assigned to the columns 210 of the grid. The numbers may be assigned exclusively with each one of the ten numbers assigned as score values 215 to one of the ten columns 210. Each square can represent a specific score in the game based on the column and row numbers. The winning wager may be determined from the least significant digit (LSD) of the score from each team, and matching those digits of the grid to find the square at the intersection of those two digits. A wager placed on the wager options associated with that square is the winning wager.

It should be appreciated that the structure illustrating the wagering game matrix 200 may be viewed as merely a visualization, data structure, or manipulation tool for an abstract collection of wager options that may be structured into a matrix (but need not be, in any strict sense). According to certain embodiments however, the wagering game matrix 200, or a similar grid or matrix, may be presented to the user 110 on a video display screen, ticket, gaming card, or other visual depiction as part of the wagering game.

According to the illustrated example, unique single digit score values 215 for “Team A” have been be assigned randomly across the columns 210 of the game matrix 200. Since the score values 215 are unique, they may be said to be dependent or non-repeating. Similarly, unique single digit score values 225 for “Team B” have been assigned randomly across the rows 220 of the game matrix 200. According to this example, assume that wagering is for a football game, all squares are purchased for $10 each, and a house rake is set to 0% (which corresponds to $0 commission to the house). The payout scenario is the final score of the football game. For sake of example, let the final score be 17 points for “Team A” and 31 points for “Team B.” Since the rows and columns of the grid represent single digits, we can select the least significant digit (LSD) of each of these scores to select the winning square. It should be appreciated that other digits of the scores or functions of the scores may be used to reduce each score to a single digit. Here the LSD is “7” for Team A and “1” for Team B. Thus, the square at the intersection of the column labeled “7” and the row labeled “1” is the winning square 230. The user 110 who placed the wager associated with the winning square 230 may be said to have purchased the winning square and in this example would win $1,000.

In this example all 100 squares of the game matrix 200 were purchased (or wagered upon), however in various example scenarios, users 110 may have purchased less than the total 100 squares, and the house may elect to purchase all remaining non-purchased squares. The house decision to purchase the non-purchased squares may be made according to a purchase algorithm as discussed herein.

Considering an example where less than all of the squares were purchased, assume that wagering is once again associated with a football game and that the purchased squares were purchased for $10 each. Assume that a rake is set to 20%, which would correspond to a commission of $200. Assume that the payout scenario is the final score of the game and the winning square 230 is once again referred to as square (7, 1). Assume that users 110 purchased a quantity of 70 of the squares and the house elected to purchase the remaining 30 squares. If a player purchased winning square 230, then that player wins $800 (100 squares times $10 cost per square minus $200 commission). In this instance, the house loses $100 ($800 payout minus $700 from accepted wagers on 70 squares at $10 each). Alternatively, if the house had purchased the winning square 230, then the house would keep the $700 collected from accepted wagers on 70 squares at $10 each and the payout would be zero dollars. While this example has the house opting to buy all remaining (non-purchased) squares, various other example scenarios may have the house opting to not purchase the remaining squares.

FIG. 3 is an example structure illustrating a wagering game matrix 300 where the house elects not to purchase all remaining non-purchased squares in accordance with one or more embodiments presented herein. The house decision not to purchase the non-purchased wager options may be made according to a calculated purchase option metric discussed herein. The game matrix 300 may be represented as a random-ordered, independently-selected integer-pair assigned to each square. Here, independently-selected implies that the integer pairs may possibly be repeated among the squares. (However, it should be appreciated that, according to one or more other embodiments, the integer pairs may be randomly drawn from an exhaustive pool of all 100 potential scoring outcomes such that the score pairs are uniquely selected and thus non-repeatable.) The integer pairs may be assigned either upon purchase of each respective square (wager option) or all at once at the initial generation of the game matrix 300. As users 110 purchase one or more wager options represented as squares within the game matrix 300, the assigned random integer pair may be kept hidden. A user 110 can win by having purchased the square that was assigned the random integer pair corresponding to the LSDs (or other digits, or functions) of the scores for the home team and the away team, respectively. If there was no square assigned the random integer pair corresponding to the proper digits of the scores for the home team and the away team, respectively, then the house keeps the wagers placed and provides no payout.

An example scenario where less than all of the squares (wager options) have been purchased may be considered. For the example, the wagering is for the final score of a football game. Each square (wager option) may be purchased for $10. A rake may be set for 20%, corresponding in a $200 commission for the house. Assume the final score to be 17 points for the home team and 31 points for the away team. The LSD is “7” for the home team and “1” for the away team. Accordingly, the player that purchased a square assigned the random integer pair (7, 1) wins. As shown in the illustrated example, only 45 of the squares were purchased prior to kickoff. Each purchased square receives a random ordered independent integer pair (note the examples of repeating random ordered integer pairs such as [8, 2] and [9, 0]). According to the illustrated example game matrix 300, there is no square assigned the random ordered integer pair that matches (7, 1). Therefore, the house profits $450 (45 purchased squares multiplied by $10 cost per square).

It should be appreciated that the house can set the rake percentage (or commission) as it sees fit to provide for its profits, but not so high as to discourage play.

FIG. 4 is an example structure illustrating a historical outcome matrix 400 in accordance with one or more embodiments presented herein. A purchase option metric may be calculated to determine the house option for purchasing any unselected wager options (matrix squares) or not. The metric calculation can apply expected values, historical data, and/or simulation results such as those illustrated in historical outcome matrix 400 where each ordered pair may have a known historical probability. For the illustrated example, final score outcomes are computed from the past ten National Football League seasons. In instances when less than 100 squares (wager options) have been purchased prior to the start of the chosen game, the option metric may be calculated to analyze the distribution of the assigned independent ordered pairs and their associated probabilities to make a determination whether the house should purchase all of the remaining squares or not.

FIG. 5 is an example structure illustrating a wagering game matrix 500 useful for dynamic wager pricing. According to one or more illustrated examples, dynamic pricing may be used to price each of the remaining wager options associated with the unpurchased squares. The integer pairs may be randomly drawn from an exhaustive pool of all one hundred potential scoring outcomes such that the score pairs are uniquely selected and thus non-repeatable. The price for the first square may be fixed and pre-specified, but the price for each successive square, or set of squares, purchased may be dependent upon a combination of the integer pairs assigned to previously purchased squares and the remaining integer pairs associated with the unpurchased squares.

### Example Processes

According to methods and blocks described in the embodiments presented herein, and, in alternative embodiments, certain blocks can be performed in a different order, in parallel with one another, omitted entirely, and/or combined between different example methods, and/or certain additional blocks can be performed, without departing from the scope and spirit of the invention. Accordingly, such alternative embodiments are included in the invention described herein.

FIG. 6 is a block flow diagram depicting a method 600 for automated wagering in accordance with one or more embodiments presented herein. In block 610, the automated wagering system 100 can specify a payout scenario. For example, the payout scenario may be the final score of a sporting game reduced to single digits by either truncation or modulo mathematics. It should be appreciated that any other payout scenarios other than a final sporting game score may be used.

According to another example payout scenario, the payout can go the user 110 who has the correct numbers, but-for the reverse order. For example, the person with the random pair (1, 7) might receive some pre-stated percentage of the total payout even though (7, 1) was the winning pair. For example (7, 1) may receive 75% of the winnings and the reverse ordered pair (1, 7) might receive 25% of the winnings.

According to yet another example payout scenario, payout may go to the squares (wager options) with the appropriately ordered combinations corresponding to a first quarter end score, and/or the second quarter end score (halftime), and/or the third quarter end score, and/or the final score. The digit-reversed pairs for each payout may also be included, thus providing many potential payout opportunities. Also, the payout may occur for only the scores at halftime and final, thus providing two potential payouts. Including the reverse digit pairs for those can provide for four payout events. In these and other situations, the pot or winnings may be evenly distributed between each of the payout events, or alternatively weighted more towards the final score, for example.

According to a still yet another example payout scenario, the first ten, or some variation thereof, scoring changes may payout. It should be appreciated that these various payout scenarios affect the expected-return, or the odds of winning, based on the predetermined payout scenario. The payout scenario may also be any other numerical event to be wagered upon including, but not limited to, the examples discussed herein.

In block 620, the automated wagering system 100 can specify a number of wager options. In the examples used herein, the number of wager options is generally one hundred given by a ten by ten matrix. It should be appreciated that there can be any other number of wager options for users 110 to wager upon. For example, the number of wager options can be reduced to 64 (eight-by-eight) simply by taking the modulo-8 of the score instead of modulo-10.

In block 630, the automated wagering system 100 can assign outcomes of the specified payout scenario to each of the specified number of wager options. According to one example, the outcomes may be assigned geometrically by placing random values 0-9 to the rows and separately to the columns of the wagering matrix 200. According to another example, the outcomes may be assigned uniquely around the wagering matrix 200 by avoiding repeat assignments. According to yet another example, the outcomes may be assigned non-uniquely around the wagering matrix 200 by allowing repeat assignments.

In block 640, the automated wagering system 100 can receive one or more wagers for one or more users 110. Each wager may be for a unique selected wager option. The users 110 may select their wager options via the user terminal 120 which may be paper-based, or any computing machine such as a smartphone, computer terminal, browser, or kiosk system.

In block 650, the automated wagering system 100 can receive a payment for each wager. The payment amount may be specified before the start of wagering. The payment amount may be the same for each wager option (each matrix square) or the payment amount may vary from wager option to wager option based upon various historical or expectation statistics.

One example of a dynamic pricing model may be employed when the wager options outcome numbers (the square's integer pairs) are randomly drawn from an exhaustive pool of all potential scoring outcomes such that the score pairs are uniquely selected and thus non-repeatable. The price for the first square may be fixed and pre-specified, but the price for each successive square (wager option), or set of squares, purchased may be dependent upon a combination of the integer pairs assigned to previously purchased squares and the remaining integer pairs associated with the unpurchased squares. The assigned random integer pairs may be revealed to all users 110 upon square purchase, thus the remaining integer pairs for the unpurchased squares may be known. A dynamic pricing algorithm may be used that is based upon known historical probability associated with integer pairs (such as those in the historical outcome matrix 400). The dynamic pricing algorithm may be used to determine the price for any square, or set of squares, to be purchased. The price for each successive square, or set of squares, purchased after the first square may be dependent upon the price to purchase the first square and the collective probability associated with the remaining integer pairs and the number of unpurchased squares (wager options).

In block 660, the automated wagering system 100 can cease receiving wagers in response to all wager options having been selected for a wager.

In block 670, the automated wagering system 100 can calculate a purchase option metric to determine if the house should opt to purchase any unselected wager options or not. With the option to purchase all remaining squares, the house can force exactly one square (wager option) will have been assigned the corresponding winning ordered pair. Of course that square may be owned by a user 110 or by the house. By selecting the option not to purchase the remaining squares (wager options), the random ordered independent integer pair assignments may result in the house risking a possibility of paying out multiple winners.

In block 680, the automated wagering system 100 can identify one or more winning wager options from actual payout event. For example, if the payout event is the final score of a game, once the game ends, the final score can be accessed to identify the winning wager (or wagers if they are not unique).

In block 690, the automated wagering system 100 can allocate sum of received payments to the house or a user in response to the house or the user being associated with the winning wager. If a rake percentage (commission) was specified before wagering began, that amount may of course be retained by the house from any winnings allocated to users 110.

Example Systems

FIG. 7 depicts a computing machine 2000 and a module 2050 in accordance with one or more embodiments presented herein. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 also may include volatile memories, such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attachment (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, biometric readers, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (“WAN”), local area networks (“LAN”), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

One or more aspects of embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the invention should not be construed as limited to any one set of computer program instructions. Further, a skilled programmer would be able to write such a computer program to implement an embodiment of the disclosed invention based on the appended flow charts and associated description in the application text. Therefore, disclosure of a particular set of program code instructions is not considered necessary for an adequate understanding of how to make and use the invention. Further, those skilled in the art will appreciate that one or more aspects of the invention described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (“FPGA”), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of embodiments of the invention. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of the invention defined in the following claims, the scope of which is to be accorded the broadest interpretation so as to encompass such modifications and equivalent structures.

What is claimed is:

1. A computer-implemented method for automated wagering, comprising:
specifying, within an automated wagering system, a payout scenario;
specifying, within the automated wagering system, a number of wager options;
assigning, within the automated wagering system, outcomes of the specified payout scenario to each of the specified number of wager options;
receiving, within the automated wagering system, one or more wagers from one or more users, each wager for a selected wager option;
receiving, within the automated wagering system, from the one or more users, a payment for each wager;
calculating, within the automated wagering system, a purchase option metric to determine if house should opt to purchase unselected wager options;
identifying, within the automated wagering system, a winning wager from actual payout event; and
allocating, within the automated wagering system, some or all of the received payments to one or more of the one or more users in response to the user being associated with the winning wager; and
allocating the received payments not allocated to the user to the house.

2. The computer-implemented method of claim 1, wherein the number of wager options is one hundred.

3. The computer-implemented method of claim 1, wherein assigning outcomes of the specified payout scenario comprises assigning outcomes geometrically by random rows and columns.

4. The computer-implemented method of claim 1, wherein assigning outcomes of the specified payout scenario comprises assigning outcomes uniquely by avoiding repeat assignments.

5. The computer-implemented method of claim 1, wherein assigning outcomes of the specified payout scenario comprises assigning outcomes allowing repeat assignments.

6. The computer-implemented method of claim 1, wherein receiving the payment for each wager comprises receiving a fixed payment that is pre-established as the same for all wager options.

7. The computer-implemented method of claim 1, wherein receiving the payment for each wager comprises receiving payments that are dynamically based upon previous payments and related wager option outcomes.

8. The computer-implemented method of claim 1, wherein the purchase option metric is calculated as a function of historical wager option outcome statistics.

9. The computer-implemented method of claim 1, wherein allocating the received payments not allocated to the user to the house comprises allocating pre-specified commissions to the house.

10. An automated wagering system, comprising:
one or more processing units, and one or more processing modules, wherein the automated wagering system is configured by the one or more processing modules to:
specify, within the automated wagering system, a payout scenario;
specify, within the automated wagering system, a number of wager options;
assign, within the automated wagering system, outcomes of the specified payout scenario to each of the specified number of wager options;
receive, within the automated wagering system, one or more wagers from one or more users, each wager for a selected wager option;
receive, within the automated wagering system, from the one or more users, a payment for each wager;
calculate, within the automated wagering system, a purchase option metric to determine if house should opt to purchase unselected wager options;
identify, within the automated wagering system, a winning wager from actual payout event; and
allocate, within the automated wagering system, some or all of the received payments to one or more of the one or more users in response to the user being associated with the winning wager; and
allocate the received payments not allocated to the user to the house.

11. The automated wagering system of claim 10, wherein the number of wager options is one hundred.

12. The automated wagering system of claim 10, wherein assigning outcomes of the specified payout scenario comprises assigning outcomes geometrically by random rows and columns.

13. The automated wagering system of claim 10, wherein assigning outcomes of the specified payout scenario comprises assigning outcomes uniquely by avoiding repeat assignments.

14. The automated wagering system of claim 10, wherein assigning outcomes of the specified payout scenario comprises assigning outcomes allowing repeat assignments.

15. The automated wagering system of claim 10, wherein receiving the payment for each wager comprises receiving a fixed payment that is pre-established as the same for all wager options.

16. The automated wagering system of claim 10, wherein receiving the payment for each wager comprises receiving payments that are dynamically based upon previous payments and related wage option outcomes.

17. The automated wagering system of claim 10, wherein the purchase option metric is calculated as a function of historical wager option outcome statistics.

18. The automated wagering system of claim 10, wherein allocating the received payments not allocated to the user to the house comprises allocating pre-specified commissions to the house.

19. A computer program product, comprising:
a non-transitory computer-readable storage medium having computer-readable program code embodied therein that, when executed by one or more computing devices, perform a method comprising:
specifying, within an automated wagering system, a payout scenario;
specifying, within the automated wagering system, a number of wager options;
assigning, within the automated wagering system, outcomes of the specified payout scenario to each of the specified number of wager options;
receiving, within the automated wagering system, one or more wagers from one or more users, each wager for a selected wager option;
receiving, within the automated wagering system, from the one or more users, a payment for each wager;
calculating, within the automated wagering system, a purchase option metric to determine if house should opt to purchase unselected wager options;
identifying, within the automated wagering system, a winning wager from actual payout event; and
allocating, within the automated wagering system, some or all of the received payments to one or more of the one or more users in response to the user being associated with the winning wager; and
allocating the received payments not allocated to the user to the house.
